(19) United States
(12) Patent Application Publication
(10) Pub. No.: US 2026/0160128 A1
(43) Pub. Date: Jun. 11, 2026

(54) EASILY INSTALLABLE CURTAIN

(71) Applicant: HANGZHOU GIPUTA CLOTHING CO., LTD., Hangzhou (CN)

(72) Inventors: Yu PAN, Hangzhou (CN); Michael Alexander MAYER, Hangzhou (CN)

(73) Assignee: HANGZHOU GIPUTA CLOTHING CO., LTD., Hangzhou (CN)

(21) Appl. No.: 19/354,471

(22) Filed: Oct. 9, 2025

(30) Foreign Application Priority Data
Dec. 9, 2024 (CN) 2024230287870

(51) Int. Cl. E06B 9/42; E06B 9/60

(52) U.S. Cl. CPC E06B 9/42; E06B 9/60

(57) ABSTRACT

An Easily Installable Curtain, including: a support rail, connected to a supporting wall surface; a mounting bracket, including a bracket connected to the support rail and an elastic connection structure connected to the bracket; a drive unit, disposed below the support rail and rotatably connected to the elastic connection structure; and a roller-type curtain assembly, disposed below the support rail and connected to the drive unit; The drive unit is configured to drive the roller-type curtain assembly to extend and retract; By allowing the bracket to move relative to the support rail along its extension direction, the relative position between the drive unit and the roller-type curtain assembly with respect to the support rail can be adjusted. The relative position of the roller-type curtain assembly is adjustable, enabling even spacing between the left and right edges of the curtain.

### FIELD OF THE INVENTION

The invention relates to a curtain, and more particularly to an easily installable curtain.

### BACKGROUND OF THE INVENTION

Curtain installation methods generally fall into two categories: perforated installation and non-perforated (punch-free) installation. Among these, non-perforated installation has gained increasing popularity in the market due to its ease of installation and the fact that it does not cause damage to the wall structure. In such installations, a punch-free mounting mechanism is typically provided on the curtain rail, allowing for convenient attachment of curtains or similar products to locations such as window frames or door frames. In addition, curtains are generally equipped with an operating mechanism for controlling the raising and lowering of the curtain fabric. Such operating mechanisms can be classified into manual mechanical types and electric types, with manual mechanical systems being more commonly used.

However, since the operating mechanism is typically located on one side of the curtain, and installation inaccuracies may occur during mounting, the curtain fabric is often misaligned with the center of the window. As a result, uneven gaps may appear on the left and right sides, adversely affecting the light-blocking performance and overall aesthetics of the curtain.

### SUMMARY OF THE INVENTION

The present invention is directed to providing an easily installable curtain, with the objective of addressing the technical problem in the prior art wherein installation errors may occur during mounting, resulting in the curtain fabric being misaligned from the center of the window, thereby causing uneven gaps on the left and right sides.

To achieve the foregoing objective, the present invention adopts the following technical solution:

An easily installable curtain, comprising:
a support rail, configured to connect with a supporting wall surface;
a mounting bracket, comprising a bracket connected to the support rail and an elastic connection structure connected to the bracket;
a drive unit, disposed below the support rail and rotatably connected to the elastic connection structure;
a roller-type curtain assembly, disposed below the support rail and connected to the drive unit;
wherein the drive unit is configured to drive the roller-type curtain assembly to extend and retract;
the bracket is movable relative to the support rail along the extension direction of the support rail, thereby adjusting the relative position between the drive unit and the roller-type curtain assembly with respect to the support rail.

Further, the bracket is L-shaped and comprises a horizontal top surface and a vertical side surface connected to the horizontal top surface;
the horizontal top surface and the vertical side surface are connected through a bent transition portion;
the horizontal top surface is movably connected to the support rail.

Further, the elastic connection structure comprises:
a housing, connected to the bracket;
a torsion spring, disposed within the housing;
a fixing shaft; a partial structure of the fixing shaft disposed inside the housing, with the remaining portion extending through the housing as a connection end, configured to connect with the drive unit;
the partial structure of the fixing shaft is mounted inside the inner ring of the torsion spring;
an adjusting seat, mounted within the housing and fitted to the fixing shaft;
a portion of the adjusting seat is disposed within the inner ring of the torsion spring.

Further, the bracket is connected to the support rail via a connecting rail;
the connecting rail is disposed on one side of the support rail;
the bracket is slidably connected to the connecting rail.

Further, the connecting rail is provided with a rail slot adapted to the bracket, and an installation slot;
the installation slot is configured to be connected and fixed with a portion of the roller-type curtain assembly.

Further, the drive unit comprises:
a roller tube, located below the support rail and connected to one end of the roller-type curtain assembly;
a drive device, located at one end of the roller tube and configured to drive the roller tube to rotate.

Further, the drive unit comprises a damping device installed at the end of the roller tube opposite the drive device;
the damping device is configured to prevent the roller tube from rotating too fast when the roller-type curtain assembly is being raised.

Further, the support rail is connected to the supporting wall surface via a punch-free assembly;
the punch-free assembly enables the support rail to be mounted and fixed without drilling.

Further, the punch-free assembly comprises:
a base, connected to one end of the support rail;
a driving rod, provided with an external thread structure, and configured to slide along the extension direction of the support rail relative to the base, providing support during punch-free installation;
a drive wheel, connected to the driving rod via a threaded structure, configured to drive the driving rod to move;
a support block, mounted at the front end of the driving rod and configured to move axially relative to the driving rod;
an anti-slip assembly, connected to the support block and configured to contact the supporting wall surface;
an elastic member, disposed between the support block and the driving rod, with one end pressing against the support block and the other end pressing against the driving rod.

Further, the easily installable curtain comprising an assembly cover movably connected to the support rail;
when the assembly cover slides to one end of the support rail, it covers the punch-free assembly.

The advantageous effects of an easily installable curtain provided by the present invention are as follows: Compared with the prior art, the curtain with easy installation of the present invention features punch-free installation and is convenient and quick to use. The relative position of the roller-type curtain assembly is adjustable, allowing the curtain to have even gaps on the left and right sides. It is adaptable to both cord-operated systems and cordless spring systems, and has wide applicability.

### BRIEF DESCRIPTION OF THE DRAWINGS

By reading the detailed description provided with reference to the drawings of non-limiting embodiment, other features, objectives, and advantages of the invention will become more apparent:

FIG. 1: Structural schematic diagram of an easily installable curtain provided in an embodiment of the present invention.

FIG. 2: Exploded view of an easily installable curtain provided in an embodiment of the present invention.

FIG. 3: Structural schematic diagram of the punch-free assembly used in the easily installable curtain provided in an embodiment of the present invention.

FIG. 4: Exploded view of the punch-free assembly used in the easily installable curtain provided in an embodiment of the present invention.

FIG. 5: Structural schematic diagram of the base used in the easily installable curtain provided in an embodiment of the present invention.

FIG. 6: Structural schematic diagram of the driving rod used in the easily installable curtain provided in an embodiment of the present invention.

FIG. 7: Structural schematic diagram of the drive wheel used in the easily installable curtain provided in an embodiment of the present invention.

FIG. 8: Structural schematic diagrams of the support block used in the easily installable curtain provided in an embodiment of the present invention (left: one perspective view; right: another perspective view).

FIG. 9: Structural schematic diagrams of the drive unit used in the easily installable curtain provided in an embodiment of the present invention (top: perspective view; bottom: exploded view).

FIG. 10: Structural schematic diagrams of the damping device used in the easily installable curtain provided in an embodiment of the present invention (top: perspective view; bottom: exploded view).

FIG. 11: Structural schematic diagrams of the mounting seat used in the easily installable curtain provided in an embodiment of the present invention (left: one perspective view; right: another perspective view).

FIG. 12: Structural schematic diagram of the turntable used in the easily installable curtain provided in an embodiment of the present invention.

FIG. 13: Structural schematic diagram of the rotary wheel used in the easily installable curtain provided in an embodiment of the present invention.

FIG. 14: Structural schematic diagram of the shaft used in the easily installable curtain provided in an embodiment of the present invention.

FIG. 15: Structural schematic diagrams of the bracket used in the easily installable curtain provided in an embodiment of the present invention (top: perspective view; bottom: exploded view).

FIG. 16: Structural schematic diagram of the plate-like body used in the easily installable curtain provided in an embodiment of the present invention.

FIG. 17: Structural schematic diagrams of the housing used in the easily installable curtain provided in an embodiment of the present invention (left: one perspective view; right: another perspective view).

FIG. 18: Structural schematic diagrams of the fixing shaft used in the easily installable curtain provided in an embodiment of the present invention (left: one perspective view; right: another perspective view).

FIG. 19: Structural schematic diagrams of the adjusting seat used in the easily installable curtain provided in an embodiment of the present invention (left: one perspective view; right: another perspective view).

FIG. 20: Structural schematic diagrams of the torsion spring used in the easily installable curtain provided in an embodiment of the present invention (left: one perspective view; right: another perspective view).

FIG. 21: Structural schematic diagram of another easily installable curtain provided in an embodiment of the present invention.

FIG. 22: Exploded view of an easily installable curtain provided in an embodiment of the present invention.

FIG. 23: Structural schematic diagrams of the second bracket used in the easily installable curtain provided in an embodiment of the present invention (top: perspective view; bottom: exploded view).

FIG. 24: Structural schematic diagram of the second plate-like body used in the easily installable curtain provided in an embodiment of the present invention.

FIG. 25: Structural schematic diagram of the second mounting arm used in the easily installable curtain provided in an embodiment of the present invention.

FIG. 26: Structural schematic diagram of the connecting rail used in the easily installable curtain provided in an embodiment of the present invention.

Description of reference numerals:
1—support rail;
2—Punch-free assembly; 21—Base; 211—Through hole; 212—Groove; 213—Mounting rib; 22—Driving rod; 221—External thread structure; 222—Snap; 223—Mounting hole; 224—Baffle; 225—Bottom surface; 226—Positioning hole; 23—Drive wheel; 231—Internal threaded hole; 24—Support block; 241—Receiving chamber; 242—Long rod; 243—Snap; 244—Boss; 25—Anti-slip assembly; 26—Elastic member;
3—Assembly cover;
4—Drive unit; 41—Roller tube; 42—Drive device; 43—Damping device; 431—Mounting seat; 4311—Second mounting hole; 4312—First positioning slot; 4313—Round hole; 432—Turntable; 4321—Shaft hole; 4322—Stop rib; 4323—Round hole; 433—Rotary wheel; 4331—First threaded hole; 4332—Second positioning slot; 434—Shaft; 4341—Boss; 4342—Locating hole; 4343—Groove; 4344—Threaded rod; 4345—Limit catch; 435—Compression spring;
5—Mounting bracket; 51—Bracket; 511—Plate-like body; 512—First reinforcement rib; 513—First positioning structure; 514—Second positioning structure; 515—First rivet hole; 516—Second reinforcement rib; 52—Housing; 521—Cap head; 522—Positioning hole; 523—Second rivet hole; 524—First countersink hole; 53—Fixing shaft; 531—Mounting shaft portion; 532—Locating boss; 533—Baffle; 534—Second countersink hole; 54—Adjusting seat; 541—Semicircular ring; 542—Stop rib; 543—Second locating boss; 544—Adjusting-seat groove; 55—Torsion spring; 551—Torsion spring arm; 56—Rivet;
6—Curtain fabric;
7—Bottom rail assembly;
8—Second mounting bracket; 81—Second bracket; 811—Second bracket body; 812—Second mounting arm; 8121—Flat end portion; 8122—Tab portion; 82—Second housing; 83—Second fixing shaft; 84—Second adjusting seat; 85—Second torsion spring; 86—Second rivet;
9—Connecting rail; 91—Rail slot; 92—Installation slot.

### DETAILED DESCRIPTION OF THE PREFERRED EMBODIMENTS

The following provides a clear and complete description of the technical solutions in the embodiments of the present application with reference to the accompanying drawings. It is apparent that the described embodiments are only part of the embodiments of the present application, rather than all embodiments. Based on the embodiments of the present application, all other embodiments obtained by those of ordinary skill in the art without creative efforts shall fall within the scope of protection of the present application.

The terms “first,” “second,” etc., as used in the specification and claims of the present application, are intended to distinguish similar objects and are not intended to indicate a particular order or sequence. It should be understood that such designations may be interchangeable under appropriate circumstances so that the embodiments of the present application can be implemented in an order other than that illustrated or described herein. The objects referred to as “first,” “second,” etc., generally belong to the same category and are not limited in number—for example, a “first object” may refer to one or more objects. In addition, the term “and/or” as used in the specification and claims refers to any and all combinations of the associated listed items. The symbol “/” generally indicates an “or” relationship between the associated elements.

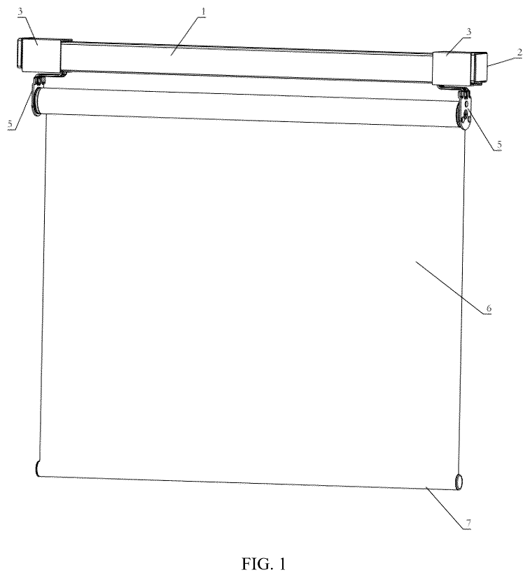

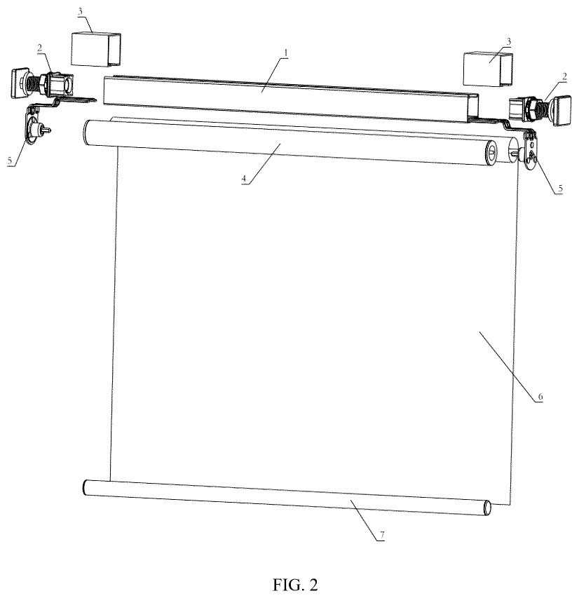

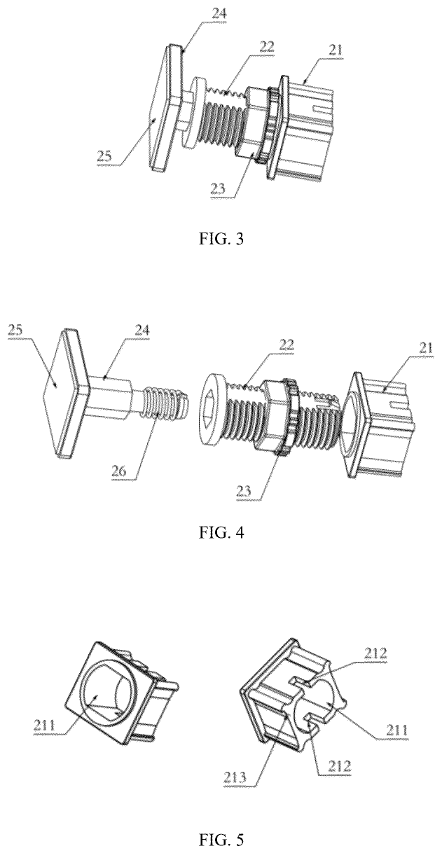

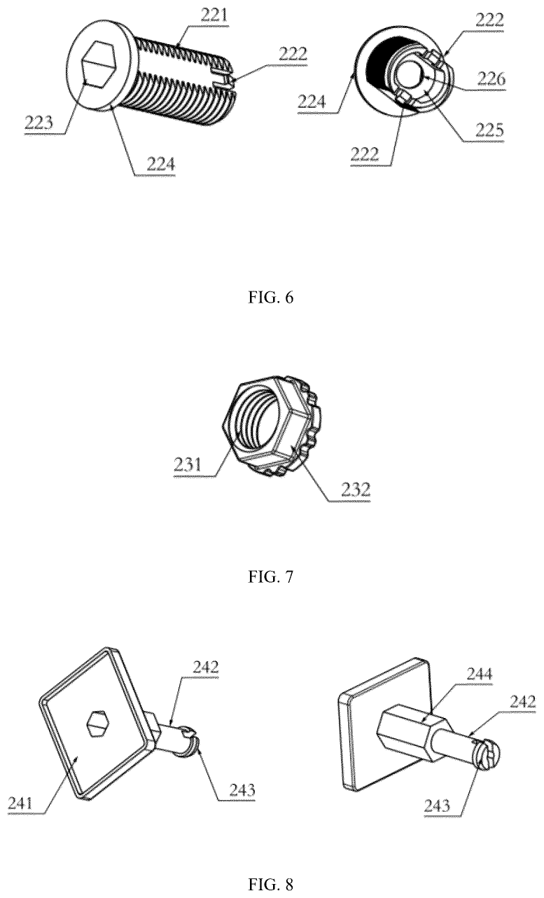

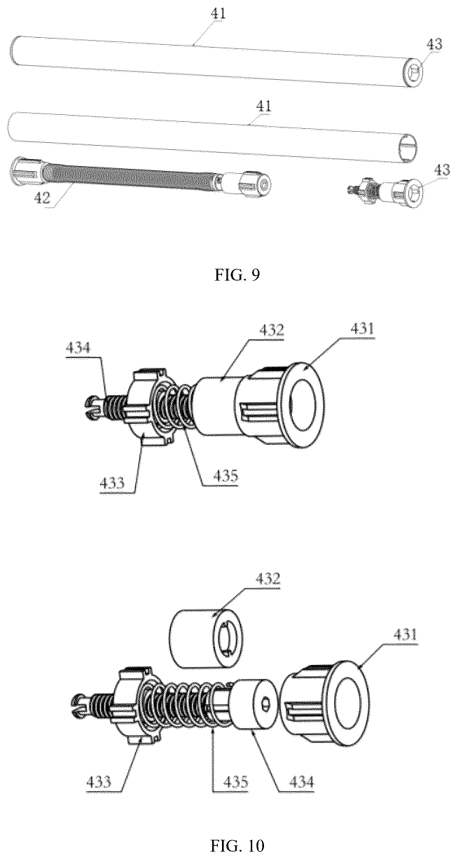

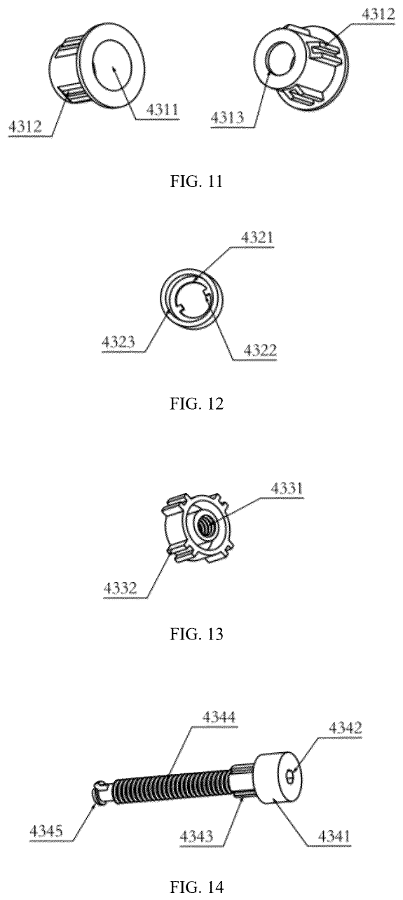

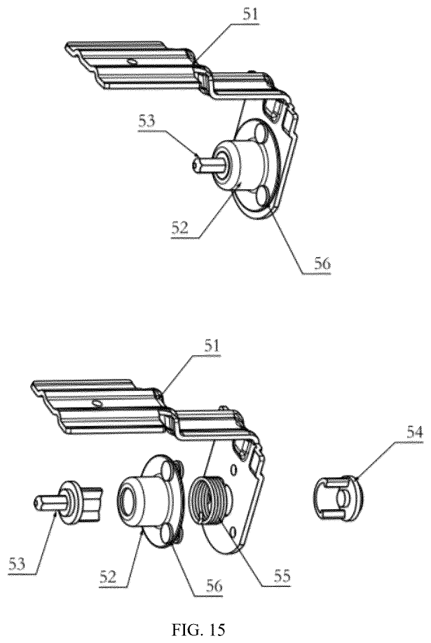

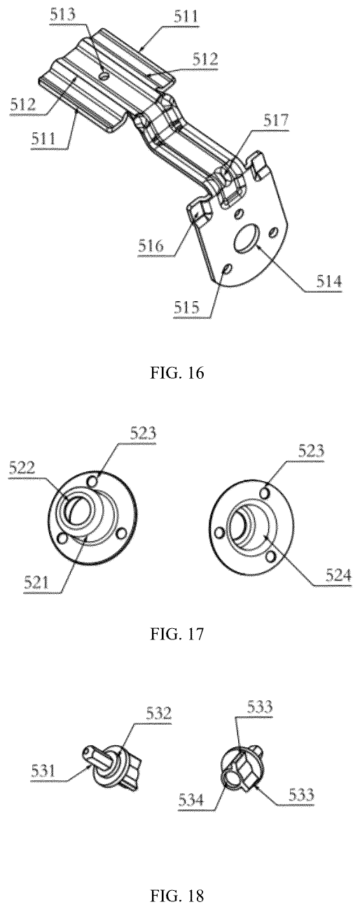

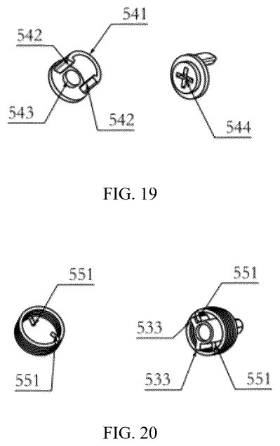

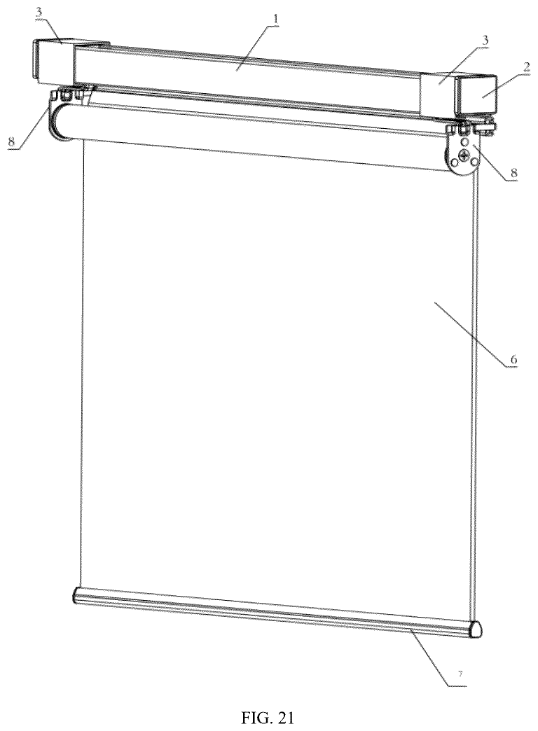

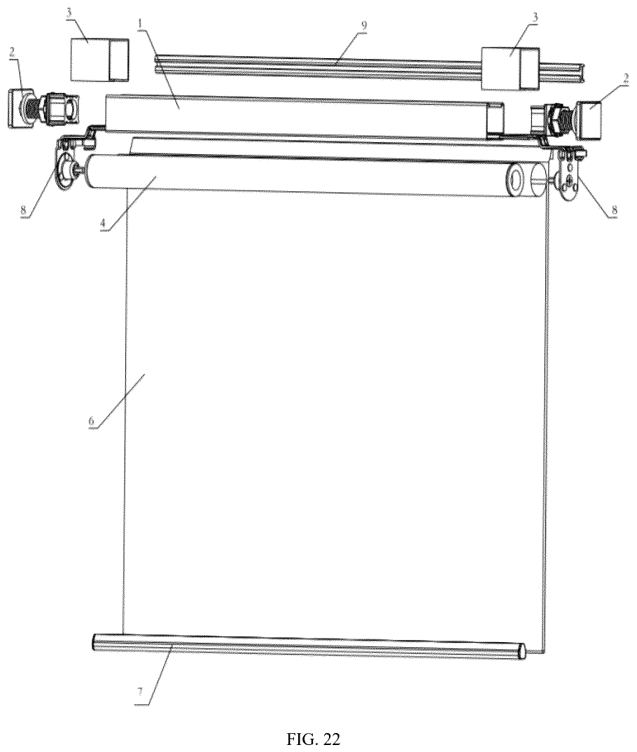

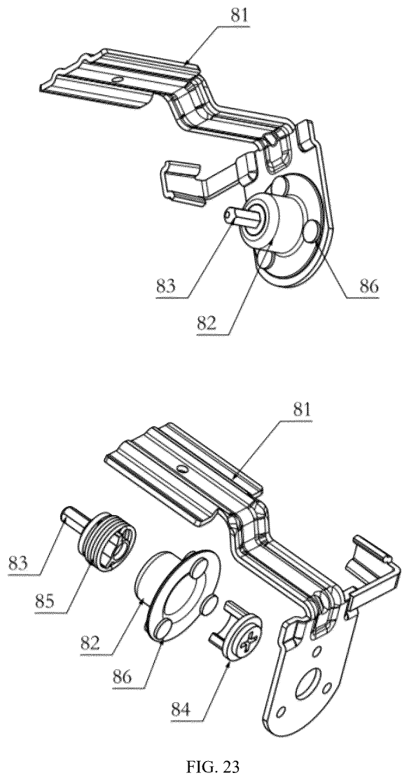

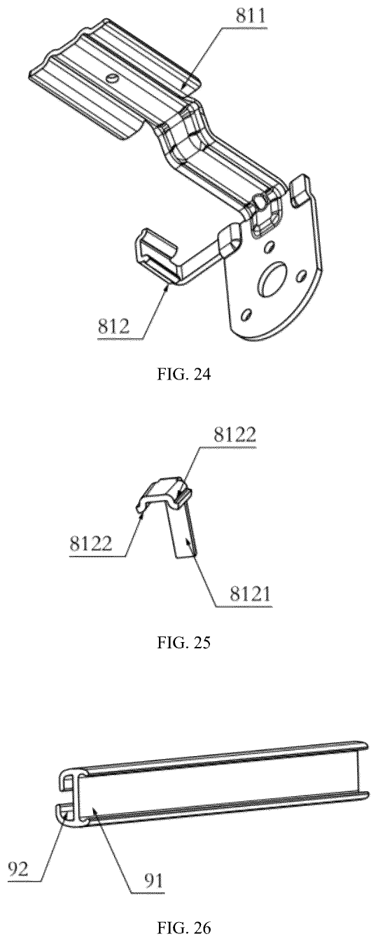

Referring now to FIGS. 1 through 26, an easily installable curtain provided by the present invention is described in detail. The easily installable curtain features adjustable gaps, punch-free installation, and convenient mounting. It includes: a support rail 1, a mounting bracket 5, a drive unit 4, and a roller-type curtain assembly. The support rail 1 is connected to a supporting wall surface. The mounting bracket 5 comprises a bracket 51 connected to the support rail 1, and an elastic connection structure connected to the bracket 51. The drive unit 4 is rotatably connected to the elastic connection structure. The roller-type curtain assembly is connected to the drive unit 4. The drive unit 4 rotates relative to the elastic connection structure and simultaneously drives the roller-type curtain assembly to rotate. By changing the specific mounting posture of the bracket 51 relative to the support rail 1, the relative position of the drive unit 4 and the roller-type curtain assembly with respect to the support rail 1 can be adjusted. In other words, by adjusting the connection posture between the bracket 51 and the support rail 1, the position of the roller-type curtain assembly relative to the support rail can be regulated.

As a specific embodiment of the present invention, and referring to FIGS. 1 through 26, the drive unit 4 is a mechanism configured to control the movement of the roller-type curtain assembly. The two ends of the drive unit 4 are respectively mounted in cooperation with the mounting bracket 5 and are installed beneath the support rail 1 via the mounting bracket 5. Specifically, one end of the roller-type curtain assembly is fixed to the drive unit 4, and the release and retraction of the roller-type curtain assembly is controlled by the rotation of the drive unit 4. More specifically, the drive unit 4 includes a roller tube 41, a drive device 42, and a damping device 43. The roller tube 41 is located below the support rail and is connected to one end of the roller-type curtain assembly. The drive device 42 is located at one end of the roller tube 41 and is configured to drive the roller tube 41 to rotate. The drive device 42 is a cordless spring mechanism, which is based on existing technology and is not a focus of this invention, and therefore is not described in detail. The damping device 43 is mounted at the end of the roller tube 41 opposite to the drive device 42, and is used to prevent the roller tube 41 from rotating too rapidly during the upward movement of the curtain.

In some feasible embodiments, the roller tube 41 is positioned below the support rail 1, with its two ends respectively provided with a drive device 42 and a damping device 43, for winding the roller-type curtain assembly.

In certain feasible embodiments, the drive device 42 is mounted at either end of the roller tube 41 and is configured to drive the roller tube 41 to rotate, thereby controlling the raising and lowering of the roller-type curtain assembly. The drive device 42 may be fixedly mounted to the mounting bracket 5, thereby enabling the drive unit 4 to be installed onto the mounting bracket 5. The drive device 42 is a cordless spring mechanism. When the curtain fabric 6 of the roller-type curtain assembly descends, the roller tube 41 rotates and releases the fabric, and the spring force of the drive device 42 increases. Correspondingly, when the fabric 6 ascends, the spring force of the drive device 42 is released. It should be noted that the drive device 42 includes: a rotating head, a fixing rod, a spring, a damper, a one-way rotary wheel, and a screw. Since the drive device 42 belongs to the prior art and is not the focus of the present invention, it will not be described in detail here for the sake of brevity.

In some feasible embodiments, the damping device 43 is mounted at the end of the roller tube 41 opposite to the drive device 42. When the curtain fabric 6 moves upward, the roller tube 41 rotates to wind the curtain fabric 6. To prevent the roller tube from rotating too rapidly, the damping device 43 can gradually increase the rotational resistance of the roller tube, thereby achieving deceleration.

In any feasible embodiment, the damping device 43 includes a mounting seat 431, a turntable 432, a rotary wheel 433, a shaft 434, and a compression spring 435. The mounting seat 431 is mounted at one end of the roller tube 41 and has an overall cylindrical shape. One end of the mounting seat 431 is provided with a second mounting hole 4311 for coupling the damping end of the drive unit 4 with the mounting bracket 5, and one end of the shaft 434 is positioned therein. The other end of the mounting seat 431 is provided with a round hole 4313, through which the other end of the shaft 434 can pass. The mounting seat 431 and the shaft 434 can rotate relative to each other around the central axis. A plurality of first positioning slots 4312 are evenly distributed around the outer circumference of the mounting seat 431. These first positioning slots 4312 are configured to engage with stop ribs inside the roller tube 41 to prevent the mounting seat 431 from rotating relative to the roller tube 41. The turntable 432 is sleeved onto the shaft 434, with one end abutting against the end of the mounting seat 431 having the round hole. The turntable 432 is provided with a shaft hole 4321 through which the shaft 434 passes. Several stop ribs 4322 are formed on the inner wall of the shaft hole for engaging with the shaft to prevent relative rotation between the turntable and the shaft. The opposite end of the turntable 432 is provided with a round hole 4323 that mates with one end of the compression spring 435, such that the spring force presses the turntable 432 against the mounting seat 431. The rotary wheel 433 is formed with a first threaded hole 4331 at its center, which mates with the threaded rod on the shaft 434, allowing the rotary wheel 433 to rotate around the shaft 434. One side of the rotary wheel 433 abuts the compression spring 435. A plurality of second positioning slots 4332 are formed on the outer circumference of the rotary wheel 433. The rotary wheel 433, as part of the damping device 43, is installed inside the roller tube 41, with the second positioning slots 4332 engaged with the stop ribs on the roller tube 41, thereby enabling the rotary wheel 433 to rotate synchronously with the roller tube 41. A boss 4341 is formed at the front end of the shaft 434 and is positioned within the mounting hole of the mounting seat. The boss 4341 cannot pass through the round hole 4313 on the mounting seat. A locating hole 4342 is formed at the center of the end surface of the boss. When the damping device 43 is mounted to the mounting bracket 5, the locating hole 4342 engages with a fixing shaft on the mounting bracket 5, preventing the shaft 434 from rotating about its axis. The locating hole is polygonal in shape. The rear end of the shaft 434 is a threaded rod 4344, which is threadably connected with the rotary wheel 433. Several grooves 4343 are provided at the connection between the boss 4341 and the threaded rod 4344. The shaft hole 4321 is sleeved over the threaded rod and engages with the grooves 4343 via the stop ribs in the shaft hole, preventing the turntable from rotating relative to the shaft. A limit catch 4345 is formed at the end of the threaded rod to prevent the rotary wheel from detaching after being installed. The compression spring 435 is disposed between the turntable 432 and the rotary wheel 433, sleeved around the threaded rod. One end of the compression spring 435 abuts the turntable 432, and the other end abuts the rotary wheel 433. As the rotary wheel 433 rotates along the threaded rod, the distance between the rotary wheel 433 and the turntable 432 changes, causing the compression spring 435 to compress or expand, thereby changing the spring force. As a result, the frictional force between the turntable 432 and the mounting seat 431 varies.

As a specific embodiment of the present invention, and referring to FIGS. 1 through 26, the support rail 1 is connected to the supporting wall surface via punch-free assemblies 2. Two sets of punch-free assemblies 2 are provided, and are respectively mounted at the ends of the support rail 1. The punch-free assemblies 2 are configured to abut against the supporting wall surface, enabling quick installation of the curtain. Each punch-free assembly 2 includes a base 21, a driving rod 22, a drive wheel 23, a support block 24, an anti-slip assembly 25, and an elastic member 26. The base 21 is connected to one end of the support rail 1. The driving rod 22 is provided with external threads and is slidable relative to the base 21 in the extension direction of the support rail 1, providing structural support during punch-free installation. The drive wheel 23 is threadably connected to the driving rod 22 and is configured to drive the movement of the driving rod. The support block 24 is mounted at the front end of the driving rod 22 and can extend or retract relative to the driving rod 22. The anti-slip assembly 25 is installed at the front end of the support block 24 and is configured to abut against the supporting wall surface. The elastic member 26 is a cylindrical spring disposed between the support block 24 and the driving rod 22.

In some feasible embodiments, the base 21 serves as the mounting seat of the punch-free assembly 2 and is installed at one end of the support rail 1. The outer shape of the base 21 corresponds to the profile of the rail. The base 21 is provided with through holes 211 arranged in the extension direction of the support rail 1. The through holes 211 are polygonal and are configured to receive the driving rod 22, allowing axial movement of the driving rod 22 relative to the base 21. The base 21 is further provided with several grooves 212 that engage with snaps 222 on the driving rod 22 to prevent separation of the driving rod 22 from the base 21 after installation. Mounting ribs 213 are formed on the outer periphery of the base 21; when the base is installed into the rail, the mounting ribs abut the inner wall of the rail.

In some feasible embodiments, the driving rod 22 is a cylindrical component mounted on the base 21. It is fitted with the through hole 211 of the base 21, allowing axial movement relative to the base 21 but preventing relative rotation. An external thread 221 is formed on the outer circumferential surface of the driving rod 22, which engages with an internal thread 231 on the drive wheel 23. A snap 222 is provided on the rear end of the outer side of the driving rod 22 and engages with the groove 212 on the base, thereby preventing the driving rod from separating from the base after installation. The front end of the driving rod 22 is provided with a mounting hole 223 for mounting the support block 24. The mounting hole 223 is polygonal in shape, and once installed, the support block can only move axially relative to the driving rod and cannot rotate. A baffle 224 is formed on the outer diameter at the front end of the driving rod 22. The outer dimension of the baffle 224 is larger than that of the through hole 211 in the base, which prevents the front end of the driving rod from passing through the through hole. A bottom surface 225 is formed inside the cylinder of the driving rod 22, and a positioning hole 226 is formed on the bottom surface. When the support block 24 is assembled with the driving rod 22, one end of the support block passes through the positioning hole 226.

In some feasible embodiments, the drive wheel 23 is located between the base 21 and the driving rod 22, and is threadably connected to the driving rod. By rotating the drive wheel, the driving rod can be driven to move relative to the base, thereby enabling the punch-free assembly to generate supporting force against the wall surface. The drive wheel 23 is provided with an internal threaded hole 231, which engages with the external thread 221 on the driving rod. The drive wheel is hexagonal in shape, making it easy to tighten using tools such as a wrench.

In some feasible embodiments, the support block 24 is mounted on the driving rod 22 and abuts the supporting wall surface. A receiving cavity 241 is formed at the front end of the support block 24 for accommodating the anti-slip assembly 25. The rear end of the support block is a long rod 242, which is installed into the mounting hole 223 of the driving rod 22 and allows axial movement of the support block relative to the driving rod. A polygonal boss 244 is formed on the end of the long rod 242 near the receiving cavity. This boss engages with the mounting hole of the driving rod to prevent relative rotation. A snap 243 is formed on the other end of the long rod 242, which passes through the positioning hole 226 of the driving rod to prevent separation of the support block from the driving rod.

In some feasible embodiments, the anti-slip assembly 25 is installed in the receiving cavity 241 at the front end of the support block. When the support rail 1 is installed, the anti-slip assembly 25 comes into contact with the supporting wall surface to prevent relative sliding between the support rail 1 and the contact surface. In any feasible embodiment, the anti-slip assembly 25 is a silicone pad.

In some feasible embodiments, the elastic member 26 is sleeved around the long rod 242 at the rear end of the support block 24. One end of the elastic member abuts the end face of the polygonal boss 244 on the long rod, and the other end abuts the bottom surface 225 inside the cylindrical body of the driving rod 22. This generates an elastic force between the support block 24 and the driving rod 22, producing a preload force against the supporting wall surface. In any feasible embodiment, the elastic member 26 is a cylindrical spring.

### Embodiment 1

As a specific embodiment of the present invention, and referring to FIGS. 1 through 26, the support bracket 51 is generally L-shaped and includes a horizontal top portion and a vertical side portion. The horizontal top portion is connected to the vertical side portion. In any feasible embodiment, the horizontal top portion and the vertical side portion are connected via a bent transition portion. Specifically, the bent portion is a stepped plate structure. One end of the plate structure is connected to the horizontal top portion, and the other end is connected to the vertical side portion. The horizontal top portion is movably connected to the support rail 1.

Both sides of the horizontal top portion are provided with Plate-like body 511. The bottom of the support rail 1 is provided with sliding grooves adapted to the Plate-like body 511. The Plate-like body 511 can slide into the sliding grooves at the bottom of the support rail 1, allowing the bracket 51 to move only along the extension direction of the support rail 1.

A first positioning structure 513 is provided on the horizontal top portion for locking the position of the bracket 5 relative to the support rail 1. In any feasible embodiment, the first positioning structure 513 is a positioning hole. Several positioning holes may be selectively formed on the horizontal top portion. The relative position of the bracket 5 can be fixed by inserting fixing bolts, rivets, or the like from the interior of the support rail 1 to engage with the positioning holes. In another feasible embodiment, the first positioning structure 513 is a bolt that is connected to the support rail 1, with the bolt head located flush with the horizontal top portion.

Several first reinforcing ribs 512 and second reinforcing ribs 516 are provided at the transition from the top surface to the side surface of the bracket 51, ensuring the structural strength of the bracket 51. The first and second reinforcing ribs 512 and 516 are arranged along the bent L-shaped structure.

A second positioning structure 514 is formed on the vertical side surface of the bracket 51. The second positioning structure 514 is adapted to the adjustment base 54. In any feasible embodiment, the second positioning structure 514 is a positioning hole, which engages with the rear end of the adjustment base 54.

Several first rivet holes 515 are formed on the vertical side surface of the bracket 51. The housing 52 is fixed to the bracket 51 by rivets 56 through the rivet holes.

In some feasible embodiments, the housing 52 is generally dome-shaped and includes a cap head 521, a positioning hole 522, and a first countersink hole 524. The cap head 521 is used for positioning and mounting with the drive unit 4. The positioning hole 522 allows one end of the fixing shaft 53 to pass through. The first countersink hole 524 is designed so that its inner wall fits tightly with the outer diameter of the torsion spring 55.

In any feasible embodiment, the housing 52 further includes a second rivet hole 523, which is used to secure the housing 52 to the bracket 51 via rivet 56.

In any feasible embodiment, the outer edge of the cap head 521 may be mounted in conjunction with both ends of the drive unit 4, enabling the drive unit 4 to rotate about its axis. A positioning hole 522 is formed at the top of the cap head 521, allowing one end of the fixing shaft 53 to pass through and fit in place. Multiple second rivet holes 523 are evenly distributed on the housing 52 for fixing it to the bracket 51 using rivets 56. The housing 52 is also provided with a first countersink hole 524 at its center. The inner wall of this first countersink hole 524 mates with the outer diameter of the torsion spring 55. According to the characteristics of helical springs, its outer diameter changes when rotated in different directions, thereby enabling unidirectional locking.

In some feasible embodiments, the fixing shaft 53 is mounted inside the housing 52 in coordination with the adjusting seat 54. The fixing shaft 53 includes a locating boss 532, a mounting shaft portion 531 disposed at one end of the locating boss 532, and a countersink portion disposed at the other end of the locating boss 532. The side of the countersink portion is provided with multiple baffles 533, and the end of the countersink portion opposite to the locating boss 532 is provided with a second countersink hole 534. The second countersink hole 534 aligns and mates with the second locating boss of the adjusting seat 54. The locating boss 532 aligns with the positioning hole 522 of the housing 52. The torsion spring 55 is sleeved over the baffles 533 and mates with the torsion spring arm 551. The mounting shaft portion 531 engages with the drive unit 4. It passes through the positioning hole 522 of the housing 52 to be installed in cooperation with the drive unit 4. The cross-sectional shape of the mounting shaft portion 531 is polygonal. The locating boss 532 fits into the positioning hole 522 on the housing. The mounting shaft portion 531 connects with the drive device 42 and the damping device 43. The mounting shaft is polygonal. Two baffles 533 are provided, arranged at a certain angle around the axis. The baffles 533 are mounted inside the inner bore of the torsion spring 55 and cooperate with the torsion spring arm 551. When the fixing shaft rotates, the outer diameter of the torsion spring 55 increases and generates frictional resistance against the inner wall of the first countersink hole 524, thereby preventing further rotation.

In some feasible embodiments, the adjusting seat 54 is mounted in the housing 52 in cooperation with the fixing shaft 53. The front end of the adjusting seat 54 is a semicircular ring 541, which is positioned inside the inner bore of the torsion spring 55. Two stop ribs 542 are provided at both ends of the semicircular ring 541, arranged at a certain angle to correspond to the baffles 533 on the fixing shaft 53. The stop ribs 542 cooperate with the torsion spring arms 551; when the adjusting seat 54 is rotated, it can cause the outer diameter of the torsion spring to decrease and disengage from the inner wall of the first countersink hole 524, thereby allowing the adjusting seat 54 to drive the torsion spring 55 and the fixing shaft 53 to rotate. A second locating boss 543 is provided at the center of the front end of the adjusting seat 54 and fits with the second countersink hole 534 on the fixing shaft 53 for positioning. The rear end of the adjusting seat 54 is provided with an adjusting-seat groove 544 to facilitate the use of a tool such as a screwdriver to rotate the adjusting seat 54.

In some feasible embodiments, the torsion spring 55 is a helical spring with torsion spring arms 551 at both ends. These arms are bent inward and positioned within the inner ring of the torsion spring. The fixing shaft 53 and the adjusting seat 54 are installed within the inner ring of the torsion spring, and the two torsion spring arms 551 are located between the baffles 533 on the fixing shaft and the stop ribs of the shaft. When the fixing shaft 53 rotates, the outer diameter of the torsion spring increases; when the adjusting seat 54 rotates, the outer diameter of the torsion spring decreases.

In some feasible embodiments, the housing 52 is fixedly connected to the bracket 51 via rivets 56.

As a specific embodiment of the present invention, the roller-type curtain assembly includes the curtain fabric 6 and the bottom rail assembly 7. One end of the curtain fabric 6 is connected to the drive unit 4, and the other end is connected to the bottom rail assembly 7.

In some feasible embodiments, the curtain fabric 6 is a woven material, and its material may include one or more of cotton, linen, or vinyl polymer. The bottom rail assembly 7 is connected to the lower end of the curtain fabric 6. It should be noted that both the curtain fabric 6 and the bottom rail assembly 7 are conventional technologies and are not the focus of this invention, so detailed descriptions are omitted for brevity.

In this embodiment, the support rail 1 is horizontally mounted inside the window frame, with punch-free assemblies 2 provided at both ends to serve as support during installation. A sliding slot is provided below the support rail 1 for mounting the mounting brackets 5, allowing the mounting brackets 5 to slide relative to it so that users can adjust their positions as needed. The punch-free assemblies 2 are installed at the ends of the support rail 1 and are in contact with the support wall surface, enabling quick installation of the curtain. Two punch-free assemblies 2 are provided. The assembly cover 3 is sleeved on the support rail 1, designed according to the external shape of the support rail 1, and can slide relative to the support rail 1. The assembly cover 3 can slide to the end of the support rail 1 to cover the punch-free assembly 2, enhancing the aesthetic appearance of the curtain rail. The drive unit 4 is a mechanism for controlling the movement of the curtain fabric. The two ends of the drive unit 4 are respectively mounted on the mounting brackets 5 and installed below the support rail 1 via the mounting brackets 5. One end of the curtain fabric 6 is fixed on the drive unit 4, and its release and retraction are controlled by the rotation of the drive unit 4. The mounting brackets 5 are symmetrically arranged below the support rail 1, with both ends of the drive unit 4 mounted thereon.

### Embodiment 2

As a specific embodiment of the present invention, please refer to FIGS. 1 through 26. The second mounting brackets 8 are symmetrically arranged beneath the support rail 1, with both ends of the drive unit 4 and both ends of the connecting rail 9 mounted thereon. The second mounting brackets 8 can optionally be adjusted relative to the support rail 1. Specifically, each second mounting bracket 8 includes a second bracket 81, a second housing 82, a second fixing shaft 83, a second adjusting seat 84, a second torsion spring 85, and second rivets 86. Among these components, only the second bracket 81 differs structurally from the mounting bracket 5 described above; therefore, only the second bracket 81 is described in detail below.

In some feasible embodiments, the second bracket 81 is integrally L-shaped and can be fixed at one end of the connecting rail 9. The second bracket 81 includes a second bracket body 811 and a second mounting arm 812. The second bracket body 811 is overall L-shaped, with its horizontal top surface and vertical side surface connected through a bent transition. The bend may be step-shaped. Its structural characteristics are substantially the same as those of the bracket 51 in Embodiment 1 and will not be described in detail. The second mounting arm 812 is also L-shaped. One end is a flat end, which is fixed to the side surface of the vertical end face of the second bracket body 811, typically via welding. The other end is a bent portion, which features a V-shaped tab that can be snapped into the rail slot of the connecting rail 9, thereby securing the connecting rail 9 to the bracket. Alternatively, the second bracket body 811 and the second mounting arm 812 may be integrally formed. The second mounting arm 812 includes a flat end portion 8121 and a tab portion 8122. The flat end portion 8121 is fixed to the second bracket body 811 (by welding or integral molding). The tab portion 8122 is V-shaped and is inserted into the rail slot 91 of the connecting rail 9.

In this embodiment, the connecting rail 9 is fixedly mounted between the second mounting brackets 8 and is positioned on one side of the support rail 1. One side of the connecting rail 9 is provided with a rail slot 91, into which the tabs 8122 on the mounting arms of the mounting brackets 8 are inserted for secure installation. The other side of the rail 9 is provided with an installation slot 92, into which the lower end of the curtain fabric 6 is fixed via the bottom rail assembly 7, thereby enabling a double-layer curtain configuration.

As a specific embodiment of the present invention, please refer to FIGS. 1 through 26. The curtain also includes an assembly cover 3 movably connected to the support rail 1. Specifically, the assembly cover 3 is sleeved over the support rail 1 and designed according to the external contour of the support rail 1, allowing it to slide along the rail. The assembly cover 3 can be slid to the end of the support rail 1 to cover the punch-free assembly 2, improving the overall aesthetic appearance of the curtain rail.

Compared with the prior art, the curtain provided by the present invention features a punch-free installation mechanism that is convenient and quick to use. The position of the curtain fabric 6 is adjustable, allowing for uniform gaps on both sides of the curtain. Moreover, the curtain is compatible with both cord-operated systems and springless systems, giving it wide applicability.

The above descriptions are merely preferred embodiments of the present invention and are not intended to limit the scope of the present invention. Any modifications, equivalent substitutions, or improvements made within the spirit and principle of the present invention shall fall within the scope of protection of the present invention.

What is claimed is:

1. An easily installable curtain, comprising:
a support rail, configured to connect with a supporting wall surface;
a mounting bracket, comprising a bracket connected to the support rail and an elastic connection structure connected to the bracket;
a drive unit, disposed below the support rail and rotatably connected to the elastic connection structure;
a roller-type curtain assembly, disposed below the support rail and connected to the drive unit;
wherein the drive unit is configured to drive the roller-type curtain assembly to extend and retract;
the bracket is movable relative to the support rail along the extension direction of the support rail, thereby adjusting the relative position between the drive unit and the roller-type curtain assembly with respect to the support rail.

2. The easily installable curtain according to claim 1, wherein:
the bracket is L-shaped and comprises a horizontal top surface and a vertical side surface connected to the horizontal top surface;
the horizontal top surface and the vertical side surface are connected through a bent transition portion;
the horizontal top surface is movably connected to the support rail.

3. The easily installable curtain according to claim 2, wherein the elastic connection structure comprises:
a housing, connected to the bracket;
a torsion spring, disposed within the housing;
a fixing shaft; a partial structure of the fixing shaft disposed inside the housing, with the remaining portion extending through the housing as a connection end, configured to connect with the drive unit;
the partial structure of the fixing shaft is mounted inside the inner ring of the torsion spring;
an adjusting seat, mounted within the housing and fitted to the fixing shaft;
a portion of the adjusting seat is disposed within the inner ring of the torsion spring.

4. The easily installable curtain according to claim 1, wherein:
the bracket is connected to the support rail via a connecting rail;
the connecting rail is disposed on one side of the support rail;
the bracket is slidably connected to the connecting rail.

5. The easily installable curtain according to claim 4, wherein:
the connecting rail is provided with a rail slot adapted to the bracket, and an installation slot;
the installation slot is configured to be connected and fixed with a portion of the roller-type curtain assembly.

6. The easily installable curtain according to claim 1, wherein the drive unit comprises:
a roller tube, located below the support rail and connected to one end of the roller-type curtain assembly;
a drive device, located at one end of the roller tube and configured to drive the roller tube to rotate.

7. The easily installable curtain according to claim 6, wherein the drive unit further comprises a damping device installed at the end of the roller tube opposite the drive device;
the damping device is configured to prevent the roller tube from rotating too fast when the roller-type curtain assembly is being raised.

8. The easily installable curtain according to claim 1, wherein the support rail is connected to the supporting wall surface via a punch-free assembly;
the punch-free assembly enables the support rail to be mounted and fixed without drilling.

9. The easily installable curtain according to claim 8, wherein the punch-free assembly comprises:
a base, connected to one end of the support rail;
a driving rod, provided with an external thread structure, and configured to slide along the extension direction of the support rail relative to the base, providing support during punch-free installation;
a drive wheel, connected to the driving rod via a threaded structure, configured to drive the driving rod to move;
a support block, mounted at the front end of the driving rod and configured to move axially relative to the driving rod;
an anti-slip assembly, connected to the support block and configured to contact the supporting wall surface;
an elastic member, disposed between the support block and the driving rod, with one end pressing against the support block and the other end pressing against the driving rod.

10. The easily installable curtain according to claim 8, further comprising an assembly cover movably connected to the support rail;
when the assembly cover slides to one end of the support rail, it covers the punch-free assembly.

11. The easily installable curtain according to claim 2, wherein:
the bracket is connected to the support rail via a connecting rail;
the connecting rail is disposed on one side of the support rail;
the bracket is slidably connected to the connecting rail.
